(19) United States
(12) Patent Application Publication
(10) Pub. No.: US 2005/0025131 A1
(43) Pub. Date: Feb. 3, 2005

(54) Medium access control in wireless local area network

(76) Inventors: Seong-Yun Ko, Seoul (KR); Joo-Yong Park, Seongnam-si (KR); Seong-Joon Jeon, Yongin-si (KR); Myeon-Kee Youn, Namdong-gu (KR); Soung-Kwan Kim, Suwon-si (KR)

Correspondence Address: ROBERT E. BUSHNELL, 1522 K STREET NW, SUITE 300, WASHINGTON, DC, 20005-1202, US

(21) Appl. No.: 10/891,330

(22) Filed: Jul. 15, 2004

(30) Foreign Application Priority Data
Jul. 29, 2003 (KR) 2003-52456

(51) Int. Cl. H04L 12/66; H04L 12/413

(52) U.S. Cl. 370/352; 370/445

(57) ABSTRACT

A medium access control method of a CSMA/CA (Carrier Sense Multiple Access with Collision Avoidance) based wireless LAN (Local Area Network) provides contention-free medium access authority to a station or access point receiving a request signal by: transmitting a request signal frame from an arbitrary station to another arbitrary station or to an access point via a medium occupied in transmission contention with a CSMA/CA algorithm using a DCF (Distributed Coordination Function) interframe space; and transmitting an acknowledgment signal frame from the station or the access point receiving the request signal frame to the station transmitting the request signal frame via an occupied medium using a short interframe space.

### CLAIM OF PRIORITY AND CROSS-REFERENCE TO RELATED APPLICATIONS

This application makes reference to, incorporates the same herein, and claims all benefits accruing under 35 U.S.C. §119 from an application for METHOD FOR MEDIUM ACCESS CONTROL IN WIRELESS LOCAL AREA NETWORK SYSTEM BASED ON CARRIER SENSE MULTIPLE ACCESS WITH COLLISION AVOIDANCE, AND STATION FOR PERFORMING THE SAME earlier filed in the Korean Intellectual Property Office on 29 Jul. 2003 and assigned serial No. 2003-52456.

Furthermore, the present application is related to co-pending U.S. application Ser. No. (to be determined), entitled METHOD FOR MEDIUM ACCESS CONTROL IN WIRELESS LOCAL AREA NETWORK SYSTEM BASED ON CARRIER SENSE MULTIPLE ACCESS WITH COLLISION AVOIDANCE AND APPARATUS THEREOF, based upon a Korean Patent Application Serial No. 2003-52455 filed in the Korean Intellectual Property Office on 29 Jul. 2003, and filed in the U.S. Patent & Trademark Office concurrently with the present application.

### BACKGROUND OF THE INVENTION

1. Field of the Invention

The present invention relates to a contention based wireless LAN (Local Area Network) system and a MAC (Medium Access Control) protocol and, more particularly, to decreasing medium access delay with two stations having equivalent transmission opportunities by transmitting data through an exchange procedure between a contention based request signal and a contention based acknowledgment signal on a bidirectional communication between the two stations.

2. Description of the Related Art

A wireless LAN standard of the IEEE (Institute of Electrical and Electronic Engineers) follows “Standard for Information technology-Telecommunications and information exchange between systems-Local and metropolitan area networks-Specific requirements-Part 11: Wireless LAN Medium Access Control (MAC) and Physical Layer (PHY) Specifications” 1999 Edition.

Hereinafter, the wireless LAN standard of IEEE mentioned above will be referred to as the IEEE 802.11 standard. The IEEE 802.11 standard defines regulations regarding aphysical layer configuring a wireless LAN and a MAC (Medium Access Control).

The MAC layer allows a capacity of medium to be effectively utilized by defining orders and rules that must be followed when a station or apparatus which uses a shared medium uses the medium or has access to the medium. IEEE 802.11 defines two types of access control mechanisms, that is, a DCF (Distributed Coordination Function) and a PCF (Point Coordination Function).

The PCF is a centralized medium access control mechanism based on a polling scheme, in which a PC(Point Coordinator) managing a BSS (Basic Service Set) controls medium accesses of all stations belonging to the BSS. In the DCF mode, PCF and PC are alternatively repeated, while in the PFC interval, only a station receiving a poll from a PC can have a transmission opportunity. With this scheme, it is possible for the PC to offer a contention-free transmission opportunity to a station which wishes to transmit data, according to a polling list, and thus to provide a real-time service In the wireless LAN, but the commercial use thereof is, in practice, restricted due to the complexity of PCF implementation, the inefficient use of the medium and the like.

The following patents each discloses features in common with the present invention but do not teach or suggest the inventive features specifically recited in the present application: U.S. Patent Application No. 2004/0028072 to Moutarlier, entitled COMPUTER IMPLEMENTED METHOD FOR ASSIGNING A BACK-OFF INTERVAL TO AN INTERMEDIARY NETWORK ACCESS DEVICE, published on Feb. 12, 2004; U.S. Patent Application No. 2004/0004973 to Lee, entitled METHOD FOR PERFORMING CONTENTION-BASED ACCESS FOR REAL-TIME APPLICATION AND MEDIUM ACCESS CONTROL HIERARCHY MODULE, published on Jan. 8, 2004; U.S. Patent Application No. 2003/0161340 to Sherman, entitled METHOD AND SYSTEM FOR OPTIMALLY SERVING STATIONS ON WIRELESS LANS USING A CONTROLLED CONTENTION/RESOURCE RESERVATION PROTOCOL OF THE IEEE 802.11E STANDARD, published on Aug. 28, 2003; U.S. Patent Application No. 2002/0188750 to Li, entitled NEAR OPTIMAL FAIRNESS BACK OFF METHODS AND SYSTEMS, published on Dec. 12, 2002; U.S. Pat. No. 6,671,284 to Yonge III et al., entitled FRAME CONTROL FOR EFFICIENT MEDIA ACCESS, published on Dec. 30, 2003; and U.S. Pat. No. 5,940,399 to Weizman, entitled METHODS OF COLLISION CONTROL IN CSMA LOCAL AREA NETWORK published on Aug. 17, 1999.

### SUMMARY OF THE INVENTION

It is an object of the present invention to provide medium access control of a CSMA/CA based wireless LAN system that is capable of allowing an arbitrary station configuring BSS to have the same average transmission and reception delays and opportunities on a bidirectional communication with an AP by giving contention-free medium access authority to a station including the AP receiving a request frame through an exchange between a request signal (Request) and an acknowledgment signal (ACK).

According to an aspect of the present invention for achieving these objects, there is provided a medium access control method of a CSMA/CA (Carrier Sense Multiple Access with Collision Avoidance) based wireless LAN system, comprising: transmitting arequest signal frame from an arbitrary station to another arbitrary station or an AP via an occupied medium in transmission contention with a CSMA/CA algorithm using a DIFS (DCF InterFrame Space) as an IFS (InterFrame Space); and transmitting an acknowledgment signal frame from the station or the AP receiving the request signal frame to the station transmitting the request signal frame via an occupied medium using a SIFS (Short InterFrame Space).

According to another aspect of the present invention, there is provided a medium access method of a station in a CSMA/CA based wireless LAN system comprising: coding a request signal frame into a value indicating, in a frame control field of a corresponding frame, that the corresponding frame is the request signal frame when a request signal frame is to be transmitted; transmitting the request signal frame to an arbitrary station or an AP via an occupied medium in transmission contention with a CSMA/CA algorithm using DIFS (DCF InterFrame Space); parsing a frame control field of a received frame if an arbitrary frame has been received from the arbitrary station or the AP; coding an acknowledgment signal frame into a value indicating, in the frame control field of the corresponding frame, that the corresponding frame is the acknowledgment signal frame if an acknowledgment signal frame is to be transmitted to the station or the AP transmitting the corresponding frame according to the parsed result; and transmitting the acknowledgment signal frame to the arbitrary station or the AP via a medium occupied by using SIFS (Short InterFrame Space).

According to another aspect of the present invention, there is provided a program storage device, readable by a machine, tangibly embodying a program of instructions executable by the machine to perform the medium access methods noted above.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram for explaining an access control mechanism of a DCF defined in the IEEE 802.11 standard;

FIG. 2 shows an example of a wireless LAN VoIP system in which a station for processing voice traffic, being real-time data, is connected to a wireless LAN of an infrastructure mode operated by DCF;

FIG. 3 shows data packets introduced into TX queues of AP and each station when several voice stations are connected in an arbitrary BSS configuring ESS;

FIG. 4 is a timing diagram of each station that has access to medium under a low load condition;

FIG. 5 is a timing diagram in which an AP and each station share medium in case of a high load condition;

FIG. 6 illustrates a format of a MAC frame in the IEEE 802.11 standard;

FIG. 7 illustrates a detailed structure of a frame control field as shown in FIG. 6;

FIG. 8 illustrates a combination of a type field and a subtype field;

FIG. 9 shows a subtype of a data frame further added to the frame of FIG. 8 according to an embodiment of the present invention; and

FIGS. 10 to 14 are timing diagrams showing data transmission by a request-acknowledgment exchange according to an embodiment of the present invention.

### DETAILED DESCRIPTION OF THE INVENTION

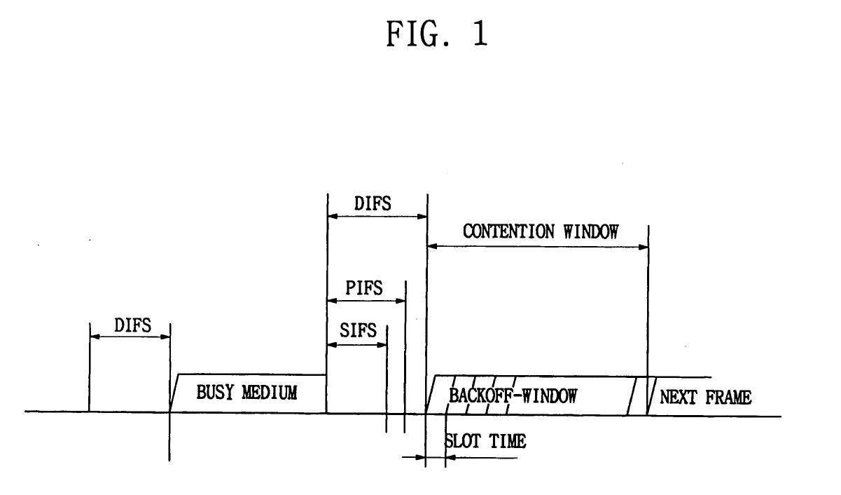

FIG. 1 is a diagram for explaining an access control mechanism of a DCF defined in the IEEE 802.11 standard.

As shown in FIG. 1, the DCF is the access control mechanism defined as a basic matter in the IEEE 802.11 standard, which uses a contention based algorithm known as CSMA/CA.

In a CSMA/CA based wireless LAN system, a station checks whether the medium is busy. If the medium is busy, the station waits for a predetermined time and then decreases its back-off time when the medium is still idle. Thus, the predetermined time, during which each station waits to initiate traffic, is called an IFS. As shown in FIG. 1, the MAC protocol traffic is largely divided into three IFSs. The DIFS, PIFS and SIFS represent a DCF interframe space, a PCF interframe space, and a short interframe space, respectively.

An example in which a station uses a DCF access control mechanism to transmit a frame is described as follows. The station using the DCF access control mechanism checks whether the medium is busy before transmitting the frame. When the medium is idle for a time longer than or equal to the DIFS (DCF interframe space), the frame can be transmitted.

On the contrary, if the medium is busy, the station initiates a back-off procedure and, when the value of a back-off timer becomes equal to zero, now occupies the medium to transmit the frame.

In the back-off procedure, a random back-off time value is assigned to the back-off timer. The back-off time follows the following relational expression:

Back-off Time=random( )*slot time

(random( )=a random integer having uniform probability distribution in [0, CW] interval)

(CW=Contention Window, CWmin<=CW<=CWmax)

The back-off time is decreased by a slot time whenever the medium remains an idle state for the slot time, but is no longer decreased when the medium is changed into a busy state at any moment.

The back-off time can be again decreased by the slot time after the medium becomes idle during the DIFS. The back-off time is not a created value, but is the value that the back-off time had immediately before the medium becomes busy.

In addition, the back-off time set in an arbitrary station will be decreased by the slot time when the medium is idle. When the station must perform a retransmission contention due to a failure in the transmission contention, the back-off time is decreased by the time slot from the value which was decreased in the previous contention process. Thus, when the back-off time is equal to zero, the station can initiate the transmission.

Even though a queue is empty, that is, there is no more data to be transmitted, a station which is successful in transmission, assigns a random back-off time to itself according to the back-off procedure. Because of it, each station necessarily needs once back-off time between the frame transmissions.

In the IEEE 802.11, error recovery can be realized by a retransmission using ‘a positive acknowledgment scheme’. A station receiving the frame without an error is adapted to receive the frame and then transmit an ACK frame following an idle state during the SIFS. The station transmitting the frame can recognize whether the frame transmitted by the station is successfully received or not, based on the presence or absence of the ACK frame.

The DCF is a medium access rule that can be used anywhere in a wireless LAN of an ad-hoc construction or an infrastructure construction. As compared to the polling scheme, the DCF is easily implemented and there is no need for the PC to perform complex calculations such as a scheduling, and since there is considerable flexibility, a station having a large amount of data to be transmitted can use more bandwidth as long as other stations occupy the medium. Moreover, all stations can be basically given fair transmission opportunities.

Fairness is achieved by a back-off procedure defined in the standard. As described above, all of the stations should have their random back-off times in the first transmission contention, and since all of them use an identical distribution function, there are equal probabilities to win the contention. If an arbitrary station loses the transmission contention, it will use in a new transmission contention with a back-off time that has been decreased from the previous contention. Thus, in the new contention, the station which has failed to obtain its transmission opportunity several times has a high probability to win the contention as compared to stations having newly prescribed back-off times, namely, stations that have just obtained their transmission opportunity. In consequence, when considering a long time period, each station will have identical transmission opportunities.

Providing fair transmission opportunities to all stations can provide an advantage of eliminating a starving phenomenon in which a specific station continues to fail to transmit data for a considerable time, by equally giving transmission opportunities to each station. However, it can generate unwanted access delay to any station handling bidirectional real-time data, such as voice traffic.

In the wireless LAN, stations transmitting and receiving real-time data should transmit data to be transmitted in an appropriate delay, and receive necessary data from the transmitting station in a limited time. In particular, if a station is processing bidirectional voice traffic, a system must be configured in such a manner that transmission and reception is made in a short period of time.

Because the DCF basically induces fair contention between the stations, the average access delay held by each station gets longer as the stations receiving a service increase in the BSS, which limits the number of real-time stations allowed to simultaneously provide transmission and reception services in the BSS of the DCF mode.

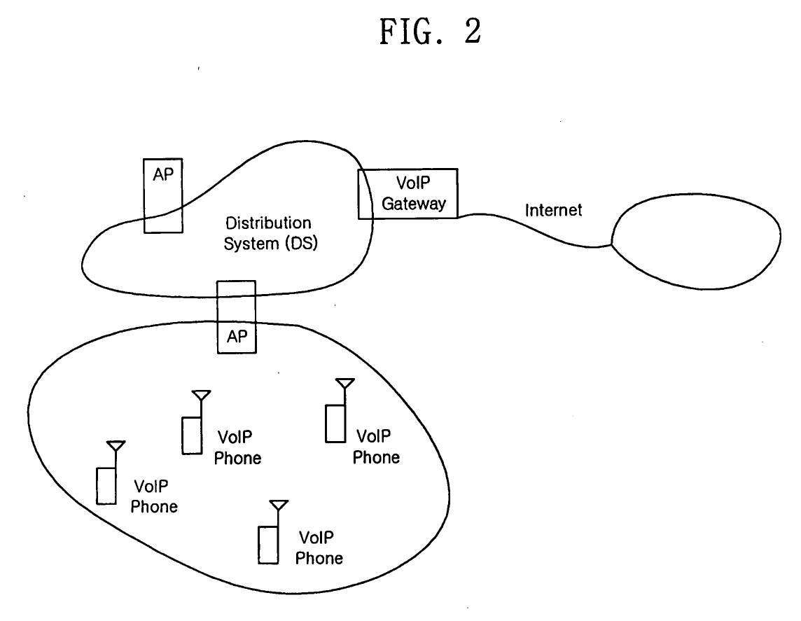

FIG. 2 shows an example of a wireless LAN VoIP system in which a station for processing voice traffic, being real-time data, is connected to a wireless LAN of an infrastructure mode operated by DCF.

An arbitrary station in the access point (AP) can transmit and receive voice information to and from a VoIP phone connected to an external Internet network via a gateway, and a DS (Distribution System) configuring a local network connecting several APs to the gateway.

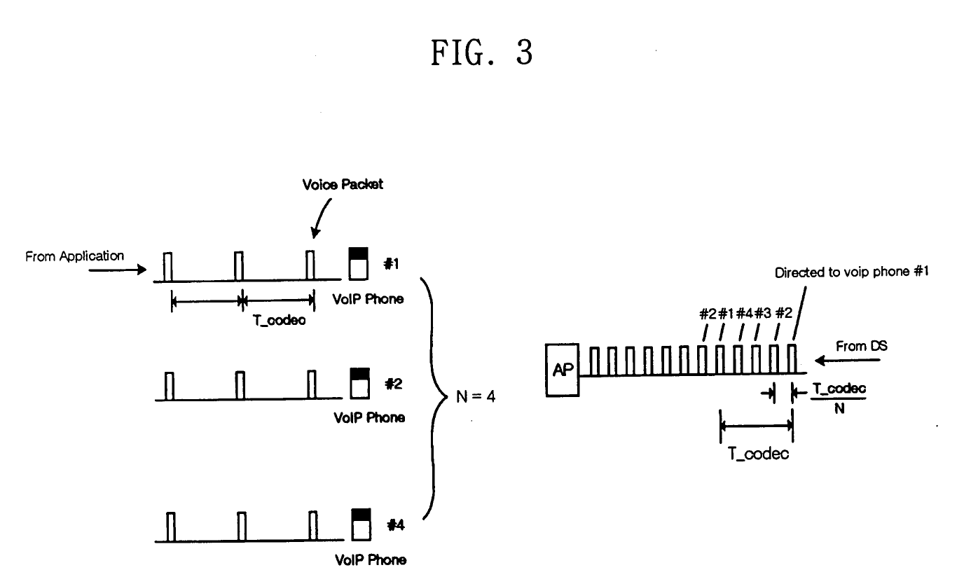

FIG. 3 shows data packets introduced into TX queues of the AP and each station when several voice stations are connected in an arbitrary BSS configuring ESS (Extended Service Set).

It is assumed that an application layer of the voice station forms voice packets in a constant period and a constant size to transmit it to a lower layer. The voice packets transmitted to the lower layer are transferred to the MAC via several protocol layers, and the MAC receiving packets from a higher layer stores the received packets in the queue. If the MAC obtains its transmission opportunity, it forms the data stored in the queue into the IEEE 802.11 frame to transmit it to the AP.

Transmission from the AP to each station has some differences. The AP will receive from the DS all frames to be transmitted to each voice station. The AP is able to transmit the frames only to one station per each transmission opportunity.

If data produced in each voice station is transmitted to the TX queues of the stations in a period of a T_codec, each voice station will have access to the medium once per the T_codec, and a transmission period T_upstream of the voice station will be the T_codec. However, because it can be easily assumed that an application of a station external to the DS is also the same as an application of any voice station positioned in the BSS, if the number of voice stations in service in the DS is N, T_from_ds, which is an arrival period of a frame arriving from the DS to the AP (TX queue of the AP), will be T_from_ds=T_codec/N, and the AP will attempt to have access to medium once per T_codec/N as long as the medium permit it. That is, if it is assumed that a transmission period of the AP is T_ap, then a transmission, if possible, will be attempted so that T_ap=T_from_ds=T_codec/N. At this time, T_downstream, which represents a period in which an arbitrary station receives necessary voice packets from the AP, becomes T_downstream=T_ap*N.

For the purpose of a normal service, the maximum permitted access delay that an arbitrary voice station can have on transmission will be the same as a maximum permitted access delay that the AP can have on a transmission to the corresponding voice station under the above stated assumption, which refers to T_permitted. Then, the following voice call service criteria must be met for the normal service:
T_upstream<T_permitted
T_downstream=T_{—}ap*N<T_permitted
Generally, T_permitted>k*T_codec is met, where, k>=1.

Medium occupation in a low load condition is described below.

If the number of stations that want to occupy the medium is small and a bandwidth of the medium used by such stations is considerably smaller than a maximum bandwidth that can be offered by the medium, that is, in the case where the medium is in the low load condition, the AP and each voice station will have an access delay shorter than a period in which data arrives in the queue.

Accordingly, since the current voice packet is carried on the MAC frame and transmitted before a new voice packet is input to the TX queue such that one MAC frame per a voice packet is used, the following conditions will be met:
T_upstream[Low_load]=T_codec
T_downstream[Low_load]=T_{—}ap[Low_load]*N=T_from_{—}ds*N=T_codec
That is, T_upstream[Low_load]=T_downstream[Low_load]<T_permitted.

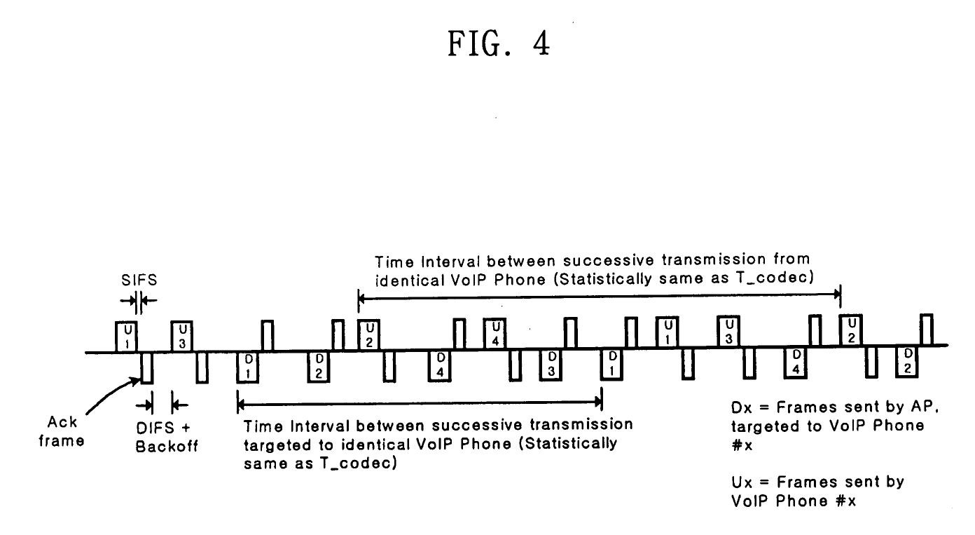

FIG. 4 is a timing diagram of each station that has access to the medium in the low load condition.

Referring to FIG. 4, since all of the voice data received by each voice station is transmitted by the AP, the AP has N times more access to the medium as compared to an arbitrary voice station, wherein N represents the number of voice stations communicating with the AP.

Of course, because T_upstream<T_permitted, and T_downstream=T_ap*N<T_permitted, the voice stations can transmit or receive real-time data with a permissible access delay. For each MAC frame transmission, a corresponding ACK frame follows.

Medium occupation in a high load condition is described below.

If there are a lot of stations that want to occupy the medium and the bandwidth of the medium used by the stations occupy a considerable portion of a maximum bandwidth that can be offered by the medium, that is, when the medium is in the high load condition, access delay increases.

That is, if there are a lot of stations participating in transmission contention and a bandwidth usage rate of the medium increases, the transmission contention between the stations is more intense such that the access delay experienced by each station (including the AP) increases. When the access delay increases, the TX queue of each voice station (and AP) accumulates a plurality of voice packets from the application layer (DS). If this situation occurs, a medium access sequence of all voice stations including the AP is determined in such a manner that they have the same transmission opportunity per unit time in view of a fairness property of the DCF.

That is, a change is made from T_ap[Low_load]=T_upstream[Low_load]/N to T_ap[High_load]=T_upstream[High_load]. Then, a relationship between a upstream period and a downstream period of each station that belongs to the network is changed as follows:
T_downstream[High_load]=T_{—}ap[High_load]*N approximately equal to T_upstream [High_load]*N

As seen from the above expression, T_downstream>T_upstream in the high load condition, which means that while T_upstream<T_permitted, T_downstream>T_permitted, and thus a voice call service may not go well.

That is, when in the high load condition, the access delay of the downstream becomes larger than the access delay of the upstream, such that a real-time service is restricted by the downstream delay. In particular, because the downstream delay experienced by each station becomes N times the transmission period of the AP (=T_ap), this phenomenon increases as the number (=N) of voice stations associated with the AP increases.

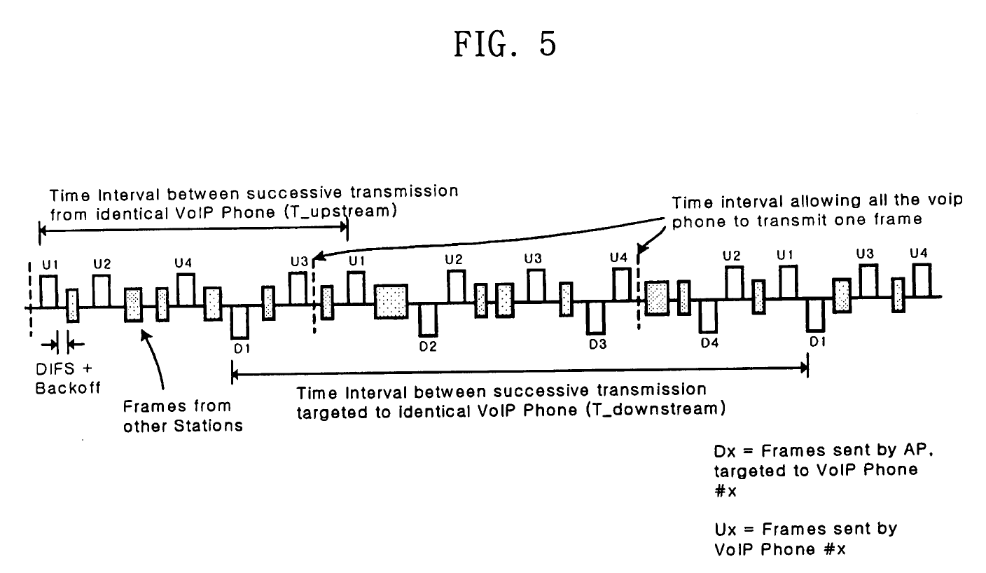

FIG. 5 is a timing diagram in which the AP and each station share the medium during the high load condition. For simplicity, an ACK frame has been omitted from FIG. 5. It is assumed that a station transmitting normal data as well as the voice station also exists in the BSS.

In order that the upstream period is the same as the downstream period, the AP must have a transmission period corresponding to 1/N times the transmission opportunities held by each station. However, the downstream period of each station is much longer than the upstream period due to a fairness property caused by the intensive transmission contention. Thus, there is a problem in that a real-time service cannot be realized.

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the features of the present invention to those skilled in the art. In the drawings, the thickness of layers and regions are exaggerated for clarity. Like numbers refer to like elements throughout the specification.

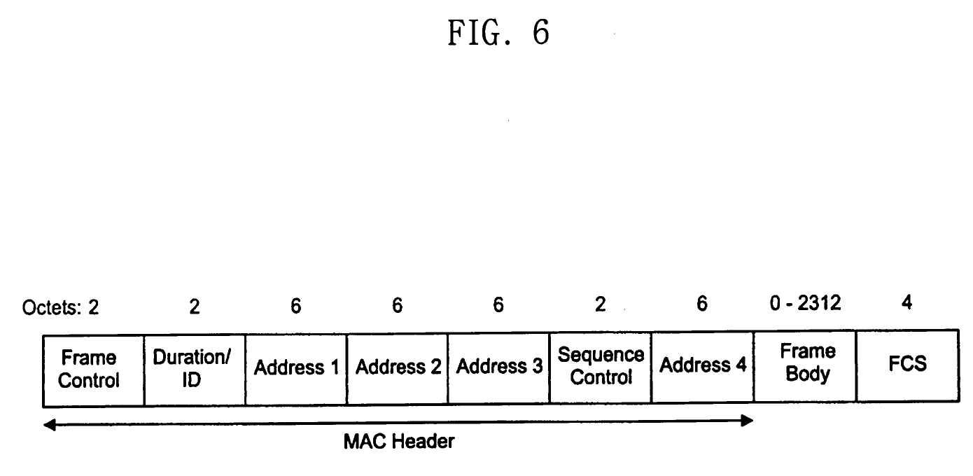

FIG. 6 illustrates a format of a MAC frame defined in the IEEE 802.11 standard.

As shown, all frames in accordance with the an embodiment of the present invention use the same format as the MAC frame type defined in the IEEE 802.11, ensuring compatibility with an existing BSS system so that both systems are easily associated. Thus, each frame according to an embodiment of the present invention basically follows the data types defined in the IEEE 802.11.

Referring to FIG. 6, the MAC frame defined in the IEEE 802.11 standard is composed of a MAC header, a frame body having specific information in a frame type, and an FCS (Frame Check Sequence).

The MAC header is composed of a frame control field, a duration field, an address field, and a sequence control field.

The frame control field indicates a property of the frame, and, from the analysis of such a frame control field, information on an attribute of the frame, power management and the like will be recognized. Accordingly, the AP and the station can recognize a status of the correspondent station transmitting the frame to the AP and the station by parsing the frame control field of the frames transmitted and received between them.

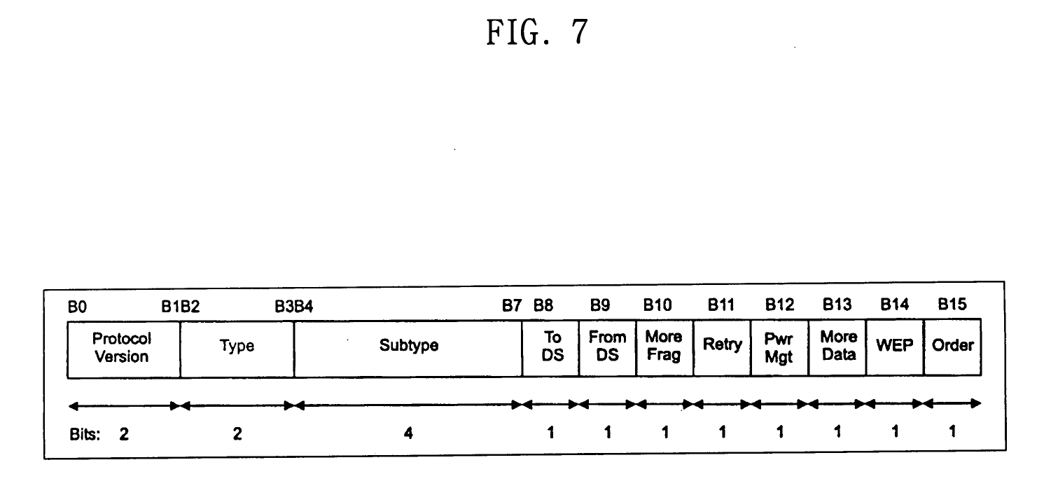

FIG. 7 illustrates a detailed structure of the frame control field as shown in FIG. 6.

Referring to FIG. 7, the frame control field is composed of a protocol version field, a type field, a subtype field, a To DS field, a From DS field, a more fragments field, a retry field, a power management field, a more data field, a WEP (Wired Equipment Privacy) field, and an order field.

The type field consists of 2 bits, and the subtype field consists of 4 bits. The type field and the subtype field represent an attribute of the frame. That is, the attribute of each frame is classified into a control frame, a data frame, and a management frame.

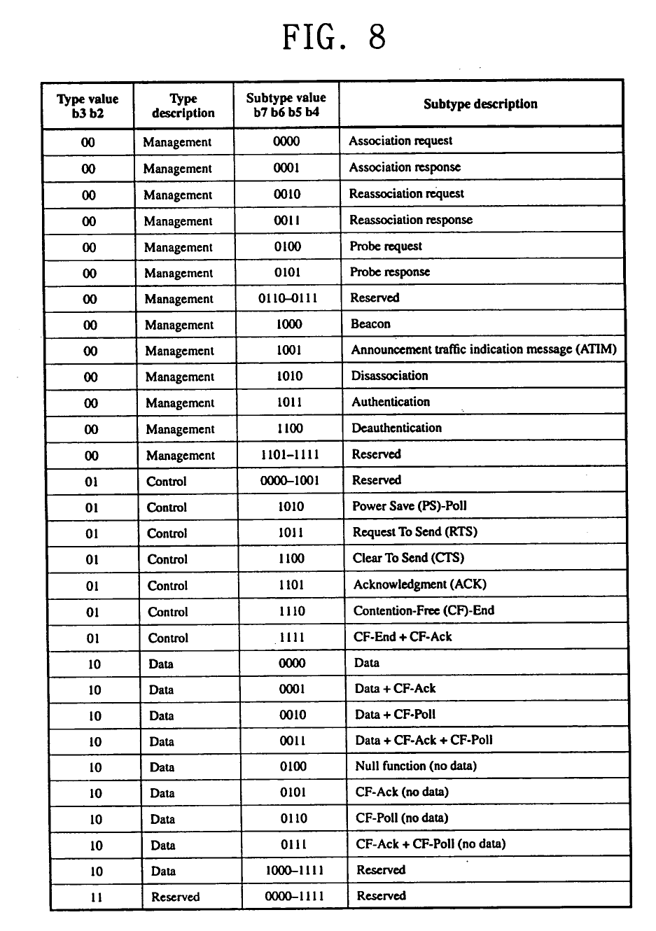

FIG. 8 illustrates a combination of the type field and the subtype field.

Referring to FIG. 8, it will be appreciated whether each frame is a frame for performing what function, based on values set in the type field and the subtype field.

If a value of the type field is ‘10’, it will be appreciated that it is the data frame. In addition, if values of the subtype field are ‘1000-1111’, it will be appreciated that each frame is still idle. Accordingly, in the present invention, idle values of the subtype field are defined so that they are used in the exchange between a request signal (Request) and an acknowledgment signal (Ack).

Accordingly, as shown, in the exchange procedure between the request signal (Request) and the acknowledgment signal (Ack), four values of Data+CB-Request, CB-Request (no data), Data+CB-Ack, and CB-Ack (no data), which follow the standard shown in the figure and are not shown, are further defined and used.

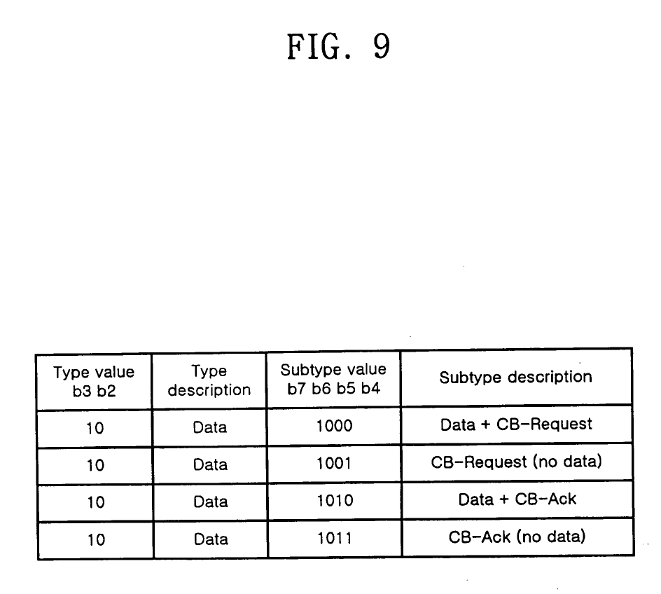

FIG. 9 shows data frames of the subtype further added to the frame of FIG. 8 according to an embodiment of the present invention.

Referring to FIG. 9, after setting values of the subtype, four values of Data+CB-Request, CB-Request (no data), Data+CB-Ack, and CB-Ack (no data) are added to the set values. Herein, the subtype values are set to 1000, 1001, 1010, and 1011 in sequence. However, these values are arbitrarily determined, and are not limited to those shown in the figure and can be varied as desired.

In an embodiment of the present invention, each frame defines the following operating rule in the wireless LAN having an Ad-hoc construction and an infrastructure construction.

First, a Data+CB-Request frame and a CB-Request (no data) frame are transmitted by all stations except for the AP.

Next, a Data+CB-Ack frame and a CB-Ack (no data) frame are transmitted by all stations including the AP.

Thus, in the BSS in which the AP is used, only stations can transmit the Data+CB-Request frame and the CB-Request (no data) frame.

In addition, according to an embodiment of the present invention, the exchange scheme of the request signal (Request) and the acknowledgment signal (Ack) follows the following procedure.

First, in the contention based wireless LAN system, any station to transmit and receive data with a request-acknowledgment exchange scheme transmits the Data+CB-Request frame or the CB-Request (no data) frame to a desired station or AP by a contention method defined by the system.

In the IEEE 802.11 based wireless LAN, a station to transmit the request frame uses the DIFS as the interframe space, as in any other data frame.

Next, the station or the AP receiving the Data+CB-Request frame or the CB-Request (no data) frame transmits, to the station transmitting the frame, the Data+CB-Ack frame or the CB-Ack (no data) frame.

At this time, if a frame check sequence (FCS) of the received frame matches, the station transmitting the Data+CB-Ack frame or the CB-Ack (no data) frame confirms that the medium is idle during the SIFS, and then performs transmission immediately. At this time, the reason for using the SIFS is that it allows having access to the medium without transmission contention with other stations by using the shortest IFS.

Then, if the station transmitting the Data+CB-Request frame or the CB-Request (no data) frame fails to receive any response from the destination station for the frame by the time that the SIFS period has elapsed after transmitting such a frame, it should recognize this as a transmission error and increase a Contention Window (CW) according to an exponential random back-off procedure defined in the DCF.

Subsequently, the station receiving the Data+CB-Ack frame waits during the SIFS when the FCS of the received frame matches and then transmits, to the station transmitting such a frame, the CB-Ack frame.

If the station transmitting the Data+CB-Ack frame fails to receive any acknowledgment signal from the destination station for the frame by the time that the SIFS period has elapsed after transmitting the frame, it recognizes this as a transmission error and completes a request-acknowledgment procedure. However, at this time, it does not increase the CW.

Thus, the Request-acknowledgment exchange is initiated by the Data+CB-Request frame or the CB-Request frame, and since the frame transmission is thoroughly based on the contention based CSMA/CA algorithm, there is no need for a point coordinator for specific management as in PCF. Further, the request-acknowledgment exchange procedure can be initiated anytime only if it follows the CSMA/CA algorithm, even though both a station supporting the request-acknowledgment scheme and a station not supporting the request-acknowledgment scheme co-exist in the BSS.

The reason is that the format of the MAC frame used in an embodiment of the present invention follows the standard defined in the IEEE 802.11 standard, and a previously unused subtype field in the frame is used in the request-acknowledgment exchange procedure according to an embodiment of the present invention. That is, in the BSS, the station supporting request-acknowledgment according to an embodiment of the present invention is subjected to the medium access procedure according to an embodiment of the present invention, while the station not supporting request-acknowledgment scheme according to an embodiment of the present invention is subjected to a medium access procedure according to a conventional procedure.

If each of the stations supporting the request-acknowledgment scheme according to an embodiment of the present invention wants to transmit a request signal frame, it codes the frame into a value indicating in a frame control field of a corresponding frame that the corresponding frame is the request signal frame.

The station transmits the request signal frame to an arbitrary station or an AP via a medium occupied in the transmission contention with a CSMA/CA algorithm using the DIFS as the IFS (Interframe Space).

If an arbitrary frame is received from the arbitrary station or the AP, the frame control field of the received frame is parsed, and when an acknowledgment signal frame is to be transmitted to the station or the AP transmitting the corresponding frame according to the parsed result, the acknowledgment signal frame is coded into a value indicating, in the frame control field of a corresponding frame, that the corresponding frame is the acknowledgment signal frame.

When the coding is completed, the station transmits the acknowledgment signal frame to the arbitrary station or the AP via a medium occupied by using the SIFS as the interframe space.

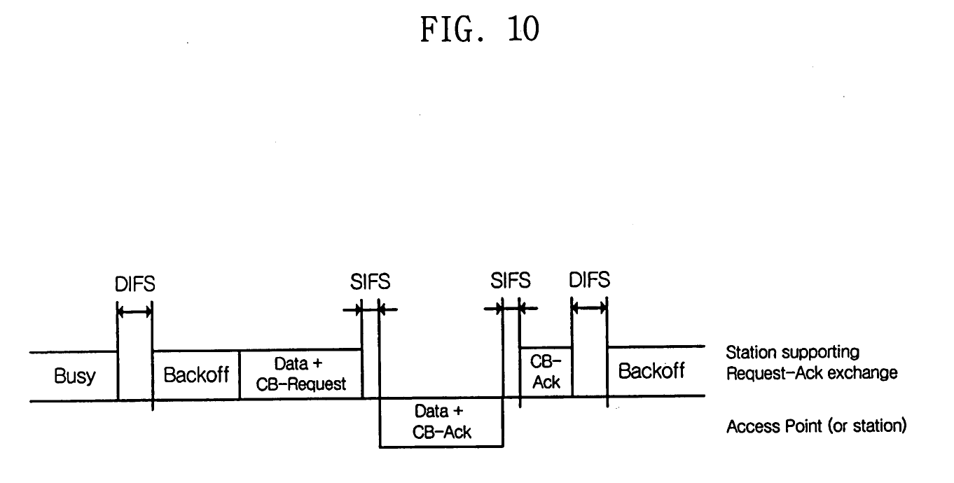

FIGS. 10 to 14 are timing diagrams showing data transmission through a request-acknowledgment exchange. In FIGS. 10 to 14, the upper portion of the horizontal axis denotes an operation of the station and the lower portion of the horizontal axis denotes an operation of the AP.

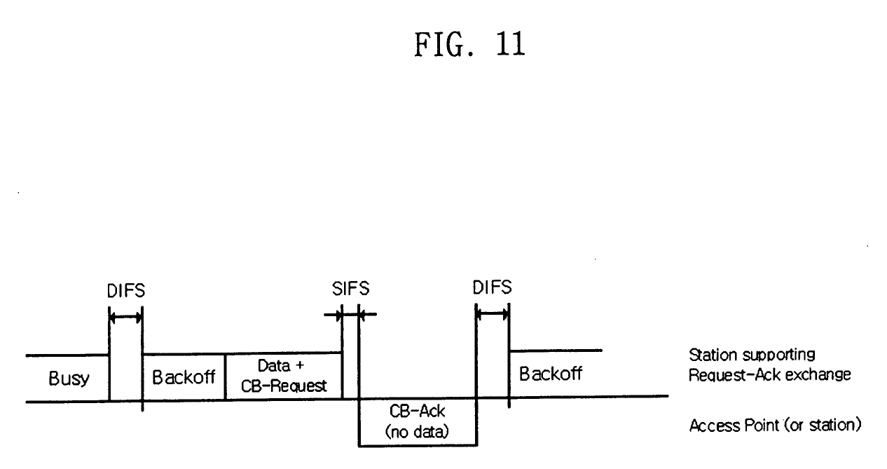

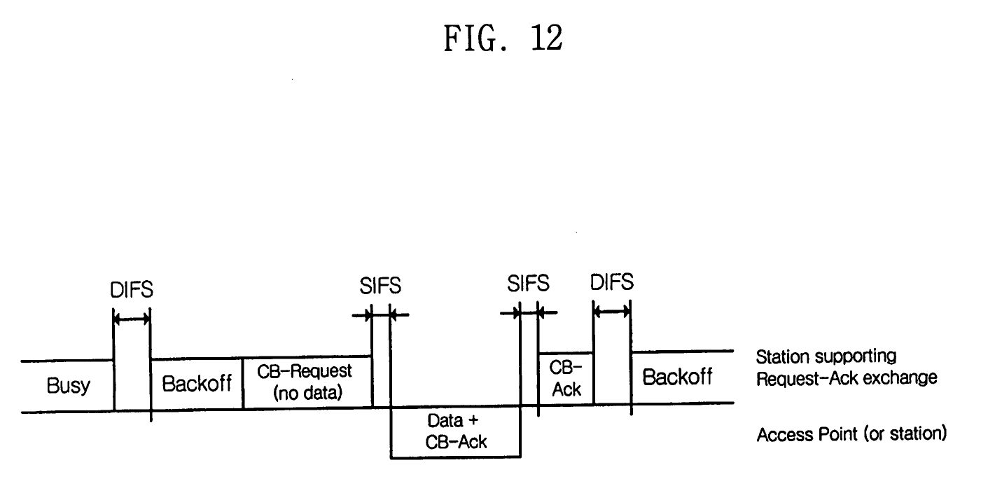

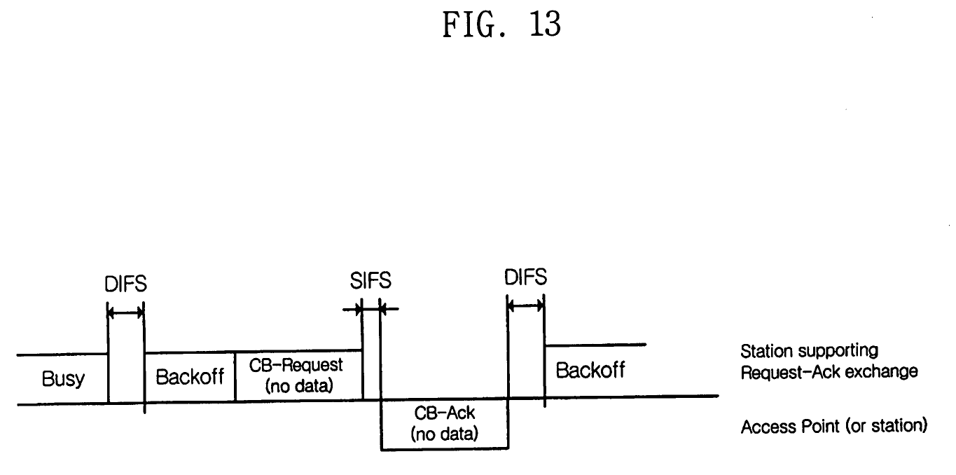

As shown in FIGS. 10 to 13, there are four cases of transmission through the Request-ACK exchange according to whether a station transmitting a request frame holds data to be transmitted to the destination station or the AP and whether the station or the AP receiving the request frame holds data to be transmitted to the transmitting station. FIG. 10 shows a case where both the station transmitting the request frame and the station or the AP receiving the same held data to be transmitted, and FIG. 11 shows a case where the station transmitting the request frame holds the data, while the station or the AP receiving the same does not hold data to be transmitted and only transmits ACK to the received data. FIG. 12 shows a case where the station transmitting the request frame does not hold data, while the station or the AP receiving the same holds the data to be transmitted, and FIG. 13 shows a case where both the station transmitting the request frame and the station or the AP receiving the request frame do not have data to be transmitted.

Thus, the AP receiving the Data+CB-Request frame or the CB-Request (no data) frame is adapted to have access to the medium without contention by transmitting the Data+CB-Ack frame immediately after the SIFS.

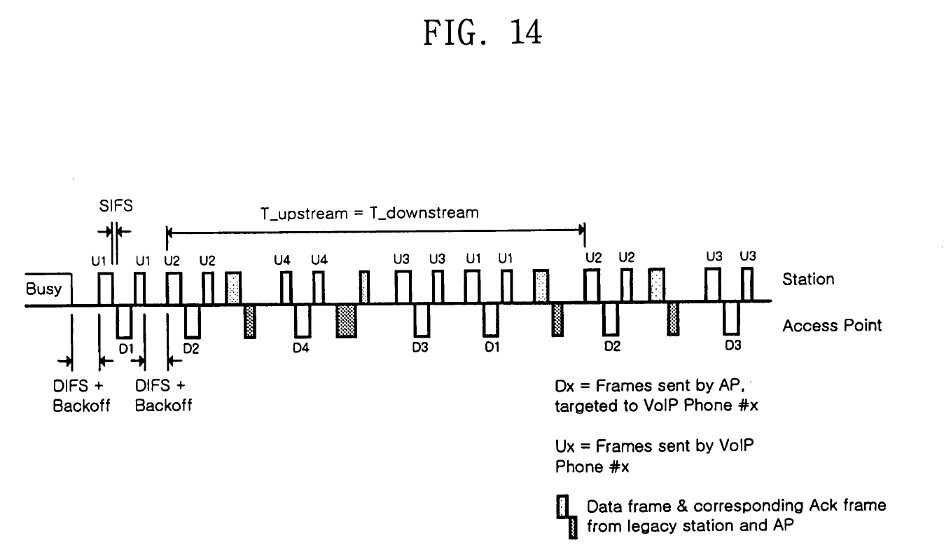

Further, because transmission and reception opportunities held by the station using the exchange between CB-Request and CB-Ack are identical, upstream and downstream periods have the same average value, as seen from FIG. 14. Here, it is assumed, however, that before receiving a request, the AP does not first transmit data to the station using the request-acknowledgment scheme. In order to make such an assumption valid, data transmission and reception between the station and the AP must only occur by the request-acknowledgment procedure when the AP is in communication with the station supporting the request-acknowledgment scheme. Otherwise, since the AP can transmit data to the station supporting the request-acknowledgment scheme by using the data frame in the DCF mode, the station can have the reception times larger than the transmission times.

Another feature of the request-acknowledgment manner is that both number of the contentions and number of the interchanged frames needed on data exchange between the station and the AP or between the station and the station are reduced, as compared to the existing IEEE 802.11 DCF scheme. Thus, overhead can be reduced, and the wireless bandwidth can be effectively used.

For example, assuming that the AP and the station once transmit data to each other, in case of the existing DCF, because one contention interval+Data frame+SIFS+Ack frame is needed on one data transmission, a total of two contention intervals plus 2*(Data Frame+SIFS+Ack Frame) is needed.

On the contrary, in the case of the request-acknowledgment scheme proposed in an embodiment of the present invention, only one contention interval plus (Data+CB-Request Frame)+(Data+CB-Ack Frame)+CB-Ack Frame+2SIFS is needed.

The present invention as described above is not limited to the above stated embodiments and the accompanying drawings since alternatives and variations thereto can occur to those skilled in the art without departing from the spirit of the present invention.

According to an embodiment of the present invention, it is possible to offer contention-free medium access authority to a station (or AP) that first receives the request signal (Request). Thus, it is possible to prevent service quality from being degraded due to increased downstream delay by allowing an arbitrary station configuring BSS to have the same average transmission and reception delays and opportunities on a bidirectional communication with an AP.

Further, it is possible to actively request data needed by an application run in the station from a correspondent station or AP without passively waiting for the data, and to reduce the throughput degradation due to collision and overhead by decreasing the number of contentions and the number of interchanged frames needed on a data exchange between a station and the AP or between stations.

1. A medium access control method comprising:
transmitting a request signal frame from an arbitrary station to another arbitrary station and an access point via a medium occupied in transmission contention with a CSMA/CA (carrier sense multiple access with collision avoidance) algorithm using a DCF (Distributed Coordination Function) interframe space; and
transmitting an acknowledgment signal frame from the station and the access point receiving the request signal frame to the station transmitting the request signal frame via an occupied medium using a short interframe space.

2. The medium access control method according to claim 1, wherein transmitting the request signal frame comprises transmitting one of a frame containing only a request signal and a frame containing both the request signal and data.

3. The medium access control method according to claim 1, wherein transmitting the acknowledgment signal frame comprises transmitting one of a frame containing only an acknowledgment signal and a frame containing both the acknowledgment signal and data.

4. The medium access control method according to claim 1, further comprising:
determining that there is a transmission error and increasing a contention window according to an exponential random back-off procedure defined in the DCF upon the station transmitting the request signal frame failing to receive the acknowledgment signal from a destination station for its frame after the short interframe space time period has elapsed after transmitting the frame.

5. The medium access control method according to claim 3, further comprising:
transmitting a corresponding acknowledgment signal frame from the station receiving the acknowledgment signal frame to the station transmitting the acknowledgment signal frame via the occupied medium using the short interframe space when the acknowledgment signal frame contains the acknowledgment signal and data.

6. The medium access control method according to claim 3, further comprising the station transmitting the acknowledgment signal frame determining that there is a transmission error and completing a request-acknowledgment procedure when it fails to receive the acknowledgment signal frame containing the acknowledgment signal and the data from the destination station after the short interframe space time period has elapsed after transmitting the acknowledgment signal frame.

7. The medium access control method according to claim 1, wherein the station transmitting the request signal is one of all stations excluding the access point in a CSMA/CA (carrier sense multiple access with collision avoidance) based wireless LAN (Local Area Network), and the station transmitting the acknowledgment signal is one of all stations including the access point.

8. A medium access method comprising:
coding a request signal frame into a value for indicating, in a frame control field of a corresponding frame, that the corresponding frame is the request signal frame when the request signal frame is to be transmitted;
transmitting the request signal frame to any one of an arbitrary station and an access point via an occupied medium in transmission contention with a CSMA/CA (carrier sense multiple access with collision avoidance) algorithm using a DCF (Distributed Coordination Function) interframe space;
parsing a frame control field of a received frame when an arbitrary frame has been received from any one of the arbitrary station and the access point;
coding an acknowledgment signal frame into a value for indicating, in a frame control field of a corresponding frame, that the corresponding frame is the acknowledgment signal frame when an acknowledgment signal frame is to be transmitted to any one of the station and the access point transmitting the corresponding frame according to the parsed result; and
transmitting the acknowledgment signal frame to any one of an arbitrary station and the access point via an occupied medium using a short interframe space.

9. The medium access method according to claim 8, wherein transmitting the request signal frame comprises transmitting one of a frame containing only a request signal and a frame containing both the request signal and data.

10. The medium access method according to claim 8, wherein transmitting the acknowledgment signal frame comprises transmitting one of a frame containing only an acknowledgment signal and a frame containing both the acknowledgment signal and data.

11. The medium access method according to claim 8, further comprising:
determining that there is a transmission error and increasing a contention window according to an exponential random back-off procedure defined in the DCF when an acknowledgment signal from a destination station for the request signal frame is not received after the short interframe space time period has elapsed after transmitting the request signal frame.

12. The medium access method according to claim 8, further comprising:
determining that there is a transmission error transmission and completing the Request-ACK procedure is completed when the transmitted acknowledgment signal frame has not been received from the destination station for the frame after the short interframe space time period has elapsed after the acknowledgment signal frame has been transmitted.

13. The medium access method according to claim 8, wherein the station transmitting the request signal is one of all stations except for the access point in a CSMA/CA (carrier sense multiple access with collision avoidance) based wireless LAN (Local Area Network), and the station transmitting the acknowledgment signal is one of all stations including the access point.

14. The medium access method according to claim 8, wherein coding an acknowledgment signal frame comprises coding a subtype field value of the frame control field into an arbitrary value to indicate whether the corresponding frame is one of the request signal frame and the acknowledgment signal frame.

15. A station of a CSMA/CA (carrier sense multiple access with collision avoidance) based wireless LAN (Local Area Network) comprising a memory adapted to store a program, and a processor connected to the memory and adapted to execute the program, the processor performing:
coding a request signal frame into a value indicating, in a frame control field of a corresponding frame, that the corresponding frame is the request signal frame when the request signal frame is to be transmitted;
transmitting the request signal frame to any one of an arbitrary station and an access point via an occupied medium in transmission contention with a CSMA/CA (carrier sense multiple access with collision avoidance) algorithm using a DCF (Distributed Coordination Function) interframe space;
parsing the frame control field of a received frame when an arbitrary frame has been received from any one of the arbitrary station and the access point;
coding an acknowledgment signal frame into a value indicating, in a frame control field of the corresponding frame, that the corresponding frame is the acknowledgment signal frame when an acknowledgment signal frame is to be transmitted to any one of the station and the access point transmitting the corresponding frame according to the parsed result; and
transmitting the acknowledgment signal frame to any one of the arbitrary station and the access point via an occupied medium using a short interframe space.

16. A program storage device, readable by a machine, tangibly embodying a program of instructions executable by the machine to perform a medium access control method comprising:
transmitting a request signal frame from an arbitrary station to another arbitrary station and an access point via a medium occupied in transmission contention with a CSMA/CA (carrier sense multiple access with collision avoidance) algorithm using a DCF (Distributed Coordination Function) interframe space; and
transmitting an acknowledgment signal frame from the station and the access point receiving the request signal frame to the station transmitting the request signal frame via an occupied medium using a short interframe space.

17. A program storage device, readable by a machine, tangibly embodying a program of instructions executable by the machine to perform a medium access method comprising:
coding a request signal frame into a value for indicating, in a frame control field of a corresponding frame, that the corresponding frame is the request signal frame when the request signal frame is to be transmitted;
transmitting the request signal frame to any one of an arbitrary station and an access point via an occupied medium in transmission contention with a CSMA/CA (carrier sense multiple access with collision avoidance) algorithm using a DCF (Distributed Coordination Function) interframe space;
parsing a frame control field of a received frame when an arbitrary frame has been received from any one of the arbitrary station and the access point;
coding an acknowledgment signal frame into a value for indicating, in a frame control field of a corresponding frame, that the corresponding frame is the acknowledgment signal frame when an acknowledgment signal frame is to be transmitted to any one of the station and the access point transmitting the corresponding frame according to the parsed result; and
transmitting the acknowledgment signal frame to any one of an arbitrary station and the access point via an occupied medium using a short interframe space.
